(19) United States
(12) Patent Application Publication
(10) Pub. No.: US 2020/0142165 A1
(43) Pub. Date: May 7, 2020

(54) COMPOSITE OPTICAL DEVICE AND SCANNING OPTICAL SYSTEM HAVING THE SAME

(71) Applicant: Hoya Candeo Optronics Corporation, Toda-shi, Saitama (JP)

(72) Inventors: Toshimitsu SAITO, Toda-shi, Saitama (JP); Shohei MATSUOKA, Tokyo (JP)

(73) Assignee: Hoya Candeo Optronics Corporation, Toda-shi, Saitama (JP)

(21) Appl. No.: 16/608,498

(22) PCT Filed: Apr. 24, 2018
(86) PCT No.: PCT/JP2018/016579

§ 371 Date: Oct. 25, 2019

(30) Foreign Application Priority Data
Apr. 27, 2017 (JP) 2017-089004

(51) Int. Cl. G02B 13/18

(52) U.S. Cl. CPC G02B 13/18

(57) ABSTRACT

In a composite optical device having a resin layer on a surface of a glass serving as a base, the resin layer has a first area corresponding to an effective diameter range and a second area disposed outside of the first area, a surface of the first area includes a concave surface of aspheric shape at least in part, and a surface of the second area is continuous with the surface of the first area, and includes an inflection point.

### TECHNICAL FIELD

The present disclosure relates to a composite optical device having a resin layer on the surface of glass serving as a base, and a scanning optical system having the composite optical device.

### BACKGROUND ART

Conventionally, in laser beam printers, laser scanners and barcode readers, a scanning optical system is used to scan a laser light on a predetermined surface. FIG. 5 is a diagram showing an example of the conventional scanning optical system, and the scanning optical system includes a semiconductor laser 1, a collimator lens 3, a light deflector 5, for example, a polygon mirror, and a fθ lens system 7, in which a laser beam L emitted from the semiconductor laser 1 is irradiated on the light deflector 5 through the collimator lens 3 and scanned by rotation of the light deflector 5, and the scanned laser beam L converges on a scan target surface 9 (for example, a photoreceptor) through the fθ lens system 7.

For high precision in the scanning optical system, to reduce the beam diameter on the scan target surface, it is necessary to suppress aberration in the fθ lens system 7, and it is desirable that a sub-scanning cross section and a main scanning cross section are aspheric. As the fθ lens system 7, for example, a hybrid lens (a composite optical device) having a resin layer formed on the glass surface is used because it is easy to form an aspheric shape (for example, Patent Literature 1).

This hybrid lens is obtained by applying an ultraviolet (UV) curable resin on the surface of the glass lens serving as a base, placing a mold machined into a predetermined shape in close contact with the UV curable resin, and in this state, irradiating a predetermined intensity of UV light from the opposing surface side of the glass to cure the UV curable resin, and removing the mold (for example, Patent Literatures 2 and 3).

### RELATED LITERATURES

### Patent Literatures

Japanese Patent Publication No. 9-49967
Japanese Patent Publication No. 2002-131512
Japanese Patent Publication No. 2006-232626

### Non-Patent Literatures

### DISCLOSURE

### Technical Problem

According to the methods disclosed by Patent Literatures 2 and 3, it is possible to form any aspheric shape in the surface of the glass lens, and obtain a desired hybrid lens. However, because the hybrid lens obtained by the methods disclosed by Patent Literatures 2 and 3 cures the ultraviolet (UV) curable resin on the surface of the glass lens, due to the influence of the cure shrinkage of the UV curable resin, the surface of the resin layer may not be formed in the shape of the molding surface of the mold, and so-called sink marks may occur. When a sink mark occurs in the surface of the resin layer, the optical performance of the hybrid lens notably degrades, resulting in low yield of the hybrid lens.

Additionally, in general, sink marks are proportional to an amount of materials and are more likely to occur as the resin layer is thicker, so its influence is remarkable when obtaining a surface shape having a large amount of sag. Additionally, when an aspheric shape of a concave surface having a large amount of sag is formed on the surface of the resin layer, the molding surface of the mold is a convex surface that matches it, and the distance between the glass lens serving as a base and the molding surface is longer at farther locations away from the center of the lens, so the close contact between the UV curable resin and the molding surface at the peripheral area of the lens is not good, and molding and transfer performance reduces.

In view of this circumstance, the present disclosure is directed to providing a composite optical device having a high precision aspheric shape irrespective of an amount of sag and a scanning optical system having the composite optical device.

### Technical Solution

To achieve the above-described object, a composite optical device of the present disclosure is a composite optical device having a resin layer on a surface of a glass serving as a base, wherein the resin layer has a first area corresponding to an effective diameter range and a second area disposed outside of the first area, a surface of the first area includes a concave surface of aspheric shape at least in part, and a surface of the second area is continuous with the surface of the first area, and includes an inflection point.

According to this configuration, because an inflection point is formed on the surface of the second area of the resin layer, an amount of sag reduces and occurrence of sink marks is suppressed. By this reason, a high precision aspheric shape is formed in the surface of the resin layer.

Additionally, preferably, the surface of the second area includes a convex surface of aspheric shape that is continuous with the concave surface, and the amount of sag is maximum at an inner position than an outer edge of the second area.

Additionally, preferably, the resin layer is formed in a rectangular shape in which horizontal and vertical dimensions of the effective diameter range are different from each other, and the concave surface and the convex surface are formed in a short side direction of the resin layer.

Additionally, preferably, the concave surface and the convex surface are formed as a single two-dimensional polynomial aspheric surface.

Additionally, preferably, the concave surface includes a quadratic function component of the two-dimensional polynomial aspheric surface in the short side direction of the resin layer, and an odd-order function component of the two-dimensional polynomial aspheric surface in a long side direction of the resin layer.

Additionally, preferably, the convex surface includes a higher order component of the two-dimensional polynomial aspheric surface that is higher than second-order.

Additionally, preferably, a shape of the surface of the first area is asymmetric in the long side direction of the resin layer.

Additionally, preferably, the amount of sag of the resin layer is 10 μm or less.

In another aspect, a scanning optical system of the present disclosure is a scanning optical system having any one composite optical device described above, wherein the scanning optical system is configured to allow a light beam deflected in a main scanning direction to pass through the composite optical device, and scan over a predetermined surface. Additionally, in this case, the composite optical device is preferably configured to correct a scan bending in the surface.

### Advantageous Effects

As described above, according to the present disclosure, it is possible to realize a composite optical device having a high precision aspheric shape irrespective of an amount of sag. Additionally, it is possible to realize a scanning optical system having the composite optical device.

### DESCRIPTION OF DRAWINGS

FIG. 1 is a diagram illustrating the configuration of a hybrid lens according to an embodiment of the present disclosure.

FIGS. 2A, 2B, 2C and 2D are diagrams illustrating a method for manufacturing a hybrid lens according to an embodiment of the present disclosure.

FIGS. 3A and 3B are graphs showing the shape of a first surface of a hybrid lens according to example 1.

FIGS. 4A and 4B are graphs showing the shape of a first surface of a hybrid lens according to comparative example 1.

FIG. 5 is a diagram showing an example of a conventional scanning optical system.

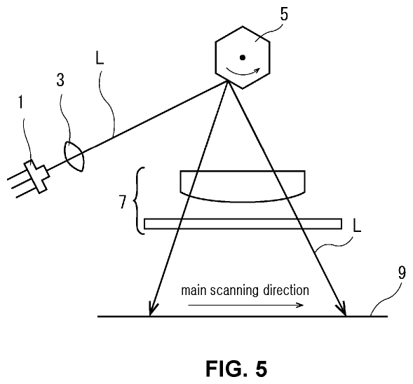

### MODE FOR INVENTION

Hereinafter, the embodiments of the present disclosure will be described in detail with reference to the accompanying drawings. Additionally, in the drawings, the same reference sign is affixed to identical or equivalent elements and its description is not repeated herein.

(Configuration of a Hybrid Lens 100 and its Manufacturing Method)

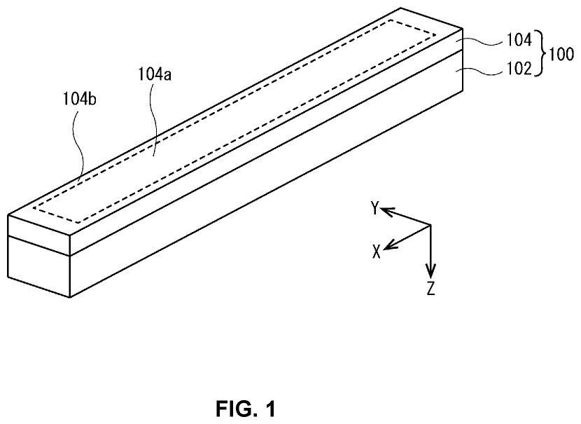

FIG. 1 is a diagram illustrating the configuration of the hybrid lens 100 according to an embodiment of the present disclosure. In a laser beam printer, the hybrid lens 100 of this embodiment is an element that is incorporated into a fθ lens system of a scanning optical system for scanning a laser light, and is a continuous lens primarily designed to correct the scan bending of a scanning beam. As shown in FIG. 1, the hybrid lens 100 includes a glass 102 of a flat plate shape and a resin layer 104 formed on the surface of the glass 102, such that the resin layer 104 side is an incident surface (first surface), and the opposing surface side of the glass 102 is an exit surface (second surface). Additionally, in this embodiment, a lengthwise direction of the hybrid lens 100 (i.e., a main scanning direction of the scanning optical system) is defined as an X-axis direction, a widthwise direction (i.e., a sub-scanning direction of the scanning optical system) is defined as a Y-axis direction, and a direction perpendicular to the X-axis direction and Y-axis direction (i.e., a thicknesswise direction of the hybrid lens 100) is defined as a Z-axis direction.

The glass 102 is an element made of glass (for example, quartz, blue plate glass, optical glass) in the shape of a rectangular flat plate that is elongated in the X-axis direction (96 mm (X-axis direction)×16 mm (Y-axis direction)×5 mm (Z-axis direction)), and the transmittance property in the wavelength band (for example, 780 nm) of the scanning laser light is preferably 90% or more. Additionally, the glass 102 preferably has the transmittance property in the ultraviolet (UV) band (for example, 365 nm) of 80% or more.

The resin layer 104 is an about 20 μm thick thin film made of a UV curable resin composition. The resin layer 104 is formed on the surface of the glass 102 by molding, and an aspheric lens is formed by the resin layer 104. As shown in FIG. 1, the resin layer 104 has a first area 104a corresponding to the effective diameter range (the range through which laser light passes), and a second area 104b disposed outside of the first area 104a. Additionally, in this embodiment, an area of 80 mm (X-axis direction)×12 mm (Y-axis direction) disposed at the central part of the resin layer 104 is set as the first area 104a. Additionally, the surface of the first area 104a is in an aspheric shape of a convex surface along the X-axis direction and a concave surface along the Y-axis direction, and the surface of the second area 104b is continuous with the first area 104a and is in an aspheric shape of a convex surface along the Y-axis direction. Additionally, the resin layer 104 of the hybrid lens 100 may use a general resin composition in which a radical polymeric monomer and a silane coupling agent are mixed at a predetermined ratio. Additionally, preferably, the resin layer 104 has approximately the same refractive index as the glass 102 to prevent incident laser light from being reflected and refracted at the interface between the glass 102 and the resin layer 104.

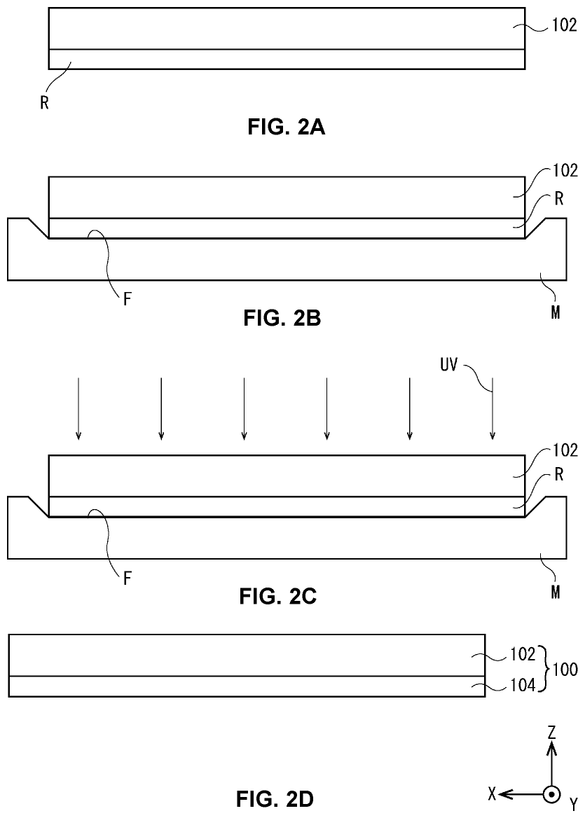

FIG. 2 is a diagram illustrating a method of manufacturing the hybrid lens 100. As shown in FIG. 2A, in the manufacturing method of this embodiment, first, a UV curable resin R is applied on a surface (a lower surface in FIG. 2A) of the glass 102. Additionally, a mold M having a molding surface F that matches a surface shape of a resin layer 104 is placed in close contact with the UV curable resin R on the surface of the glass 102, and the glass 102 is pressed toward the mold M by a pressing means not shown (FIG. 2B). Subsequently, in this state, a predetermined intensity of UV light from the opposing surface side (an upper surface in FIG. 2A) of the glass 102 is irradiated to cure the UV curable resin R (FIG. 2C). Additionally, after the UV curable resin R is cured (i.e., after the resin layer 104 is formed), the mold M is removed from the surface of the resin layer 104 to obtain the hybrid lens 100 (FIG. 2D).

As described above, the hybrid lens 100 of this embodiment is obtained by molding the resin layer 104 on the surface of the glass 102. By this reason, the yield of the hybrid lens 100 relies on molding and transfer performance of the resin layer 104, and thus, due to the influence of the cure shrinkage of the UV curable resin R, the surface of the resin layer 104 does not become the shape of the molding surface F of the mold M, and so-called sink marks may occur. Because sink marks are generally proportional to an amount of materials, sink marks are more likely to occur as the resin layer 104 is thicker. Accordingly, like the resin layer 104 of this embodiment, when the surface of the first area 104a is in an aspheric shape of a concave surface along the Y-axis direction, two end parts of Y-axis direction are thicker than the central part, where sink marks are likely to occur at this part. In this embodiment, an aspheric shape of a convex surface is formed in the surface of the second area 104b outside of the first area 104a to solve the problem (i.e., to suppress the occurrence of sink marks).

Hereinafter, the detailed shape of the first surface (the surface on the resin layer 104 side) of the hybrid lens 100 of this embodiment is described through example (example 1) and comparative example (comparative example 1).

### Example 1

The first surface of the hybrid lens 100 of example 1 is a two-dimensional polynomial aspheric surface (i.e., an aspheric surface represented by a polynomial relating to the height of each of the main scanning direction (X-axis direction) and the sub-scanning direction (Y-axis direction)). Accordingly, the height from the optical axis of each of the main scanning direction and the sub-scanning direction is an amount of sag Z(x, y) from the tangent plane to the optical axis at the point (x), (y), and the shape is represented by the following Equation (1).

Z(x,y)=1/R·(x²+y²)|[1+√(1−(κ+1)·(x²+y²)/R²}]+ΣBmn·x^{m}yⁿ (1)

In Equation (1), R is the radius of curvature of spherical component in rotational symmetry, and in example 1, it is infinite. Additionally, K is a conic coefficient, and Bmn is an aspheric coefficient of m^{th}-order in the main scanning direction and n^{th}-order in the sub-scanning direction. In example 1, to define the detailed shape of the first surface of the hybrid lens 100, each coefficient applied to Equation (1) is shown in Table 1.

TABLE 1

| | n | | | | |
|---|---|---|---|---|---|
| m | 0 | 2 | 6 | 8 | 10 |
| 0 | | −2.24600000E−04 | 1.60000000E−08 | −1.10000000E−09 | 1.90000000E−11 |
| 1 | 8.00000000E−05 | 1.76000000E−07 | 5.90000000E−10 | −2.30000000E−11 | 1.50000000E−13 |
| 2 | −2.40000000E−06 | 1.02400000E−07 | −1.00000000E−11 | 5.70000000E−13 | −8.10000000E−15 |
| 3 | −2.00000000E−08 | 9.60000000E−10 | −2.00000000E−13 | 6.00000000E−15 | |
| 4 | 8.00000000E−10 | 3.20000000E−11 | 1.80000000E−15 | −6.00000000E−17 | |
| 5 | | −7.20000000E−13 | | | |
| 6 | | −7.20000000E−15 | | | |

As shown in Table 1, the aspheric coefficients of example 1 include first-, second-, third- and fourth-order function components in the main scanning direction, and zero-, second-, sixth-, eighth- and tenth-order function components in the sub-scanning direction. That is, in the main scanning direction, odd-order function components are included, but in the sub-scanning direction, odd-order function components are not included and only even-order function components are included.

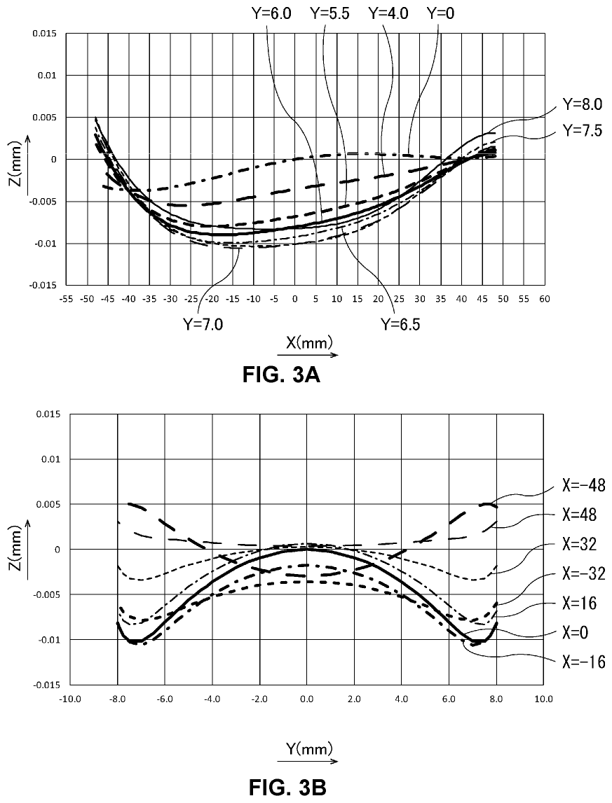

FIG. 3 is a simulation result showing the shape of the first surface (the surface on the resin layer 104 side) of the hybrid lens 100 when the aspheric coefficients of Table 1 are used. FIG. 3A is a graph showing the shape of X-axis direction (lengthwise direction), and the horizontal axis indicates the position of X-axis direction when the center position of the lengthwise direction of the hybrid lens 100 is 0 mm, and the vertical axis indicates the position of Z-axis direction when the position of the resin layer 104 surface in the center position of the lengthwise direction and widthwise direction of the hybrid lens 100 is 0 mm. Additionally, in FIG. 3A, for convenience of description, shown are only curves at the positions of Y=0 mm (i.e., the center position of the widthwise direction), 4.0 mm, 5.5 mm, 6.0 mm, 6.5 mm, 7.0 mm, 7.5 mm and 8.0 mm. Additionally, FIG. 3B is a graph showing the shape of Y-axis direction (widthwise direction), and the horizontal axis indicates the position of Y-axis direction when the center position of the widthwise direction of the hybrid lens 100 is 0 mm, and the vertical axis indicates the position of Z-axis direction when the position of the resin layer 104 surface in the center position of the lengthwise direction and widthwise direction of the hybrid lens 100 is 0 mm. Additionally, in FIG. 3B, for convenience of description, shown are only curves at the positions of X=0 mm (i.e., the center position of the lengthwise direction), ±16 mm, ±32 mm and ±48 mm. Additionally, in the hybrid lens 100 of example 1, the area of ±40 mm (X-axis direction)×±6.0 mm (Y-axis direction) is set as the effective diameter range (i.e., the first area 104a (FIG. 1)).

### Comparative Example 1

The hybrid lens of comparative example 1 has a similar configuration to the hybrid lens 100 of example 1, and has aspheric coefficients shown in Table 2.

TABLE 2

| | n | |
|---|---|---|
| m | 0 | 2 |
| 0 | | −2.24800000E−04 |
| 1 | 8.00000000E−05 | 1.76000000E−07 |
| 2 | −2.40000000E−06 | 1.02400000E−07 |
| 3 | −2.00000000E−08 | 9.60000000E−10 |
| 4 | 8.00000000E−10 | 3.20000000E−11 |
| 5 | | −7.20000000E−13 |
| 6 | | −7.20000000E−15 |

As shown in Table 2, the aspheric coefficients of comparative example 1 are the same as the aspheric coefficients of the hybrid lens 100 of example 1, but there is a difference between them in that there are zero- and second-order aspheric coefficients in the sub-scanning direction and higher order aspheric coefficients are not included.

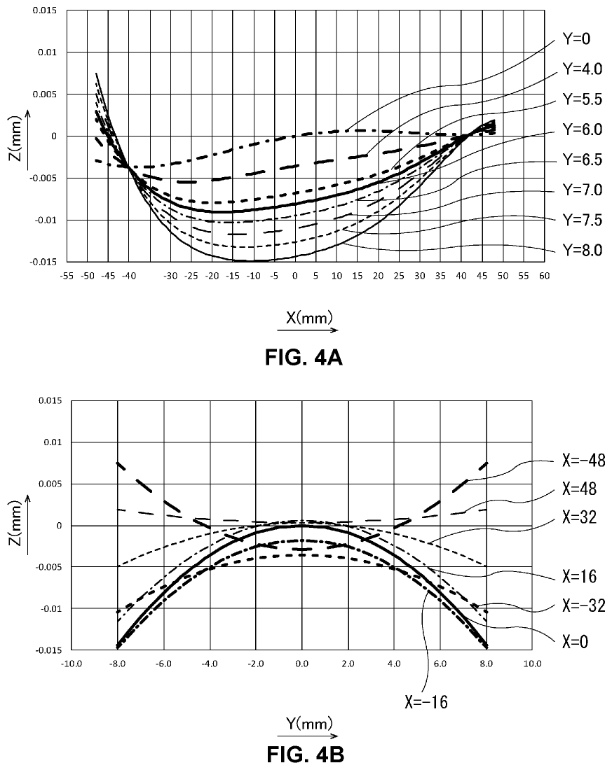

FIG. 4 is a simulation result showing the shape of the first surface of the hybrid lens of comparative example 1 when the aspheric coefficients of Table 1 are used. FIG. 4A is a graph showing the shape of X-axis direction (lengthwise direction) in the same way as FIG. 3A. Additionally, FIG. 4B is a graph showing the shape of Y-axis direction (widthwise direction) in the same way as FIG. 3B.

(Comparison of Example 1 and Comparative Example 1)

In comparison of FIGS. 3(A) and 4(A), it can be seen that when viewed from the Y-axis direction, the first surface (i.e., the surface of the resin layer 104) of the hybrid lens 100 of example 1 and the first surface of the hybrid lens of comparative example 1 are all in an aspheric shape of a convex surface protruding toward the Z-axis direction minus side in the effective diameter range (i.e., the area of ±40 mm (X-axis direction)). Additionally, the first surface of the hybrid lens 100 of example 1 and the first surface of the hybrid lens of comparative example 1 differ in the shape of X-axis direction depending on the position of Y-axis direction, and the shape of the range of X=−40 to 0 mm and the shape of the range of X=0 to +40 mm are different from each other (i.e., showing a left-right asymmetric shape).

In comparison of FIGS. 3(B) and 4(B), when viewed from the X-axis direction, the first surface of the hybrid lens 100 of example 1 is in an aspheric shape of a concave surface recessed toward the Z-axis direction plus side in the effective diameter range (i.e., the area of ±40 mm (X-axis direction)×±6.0 mm (Y-axis direction)). Additionally, the first surface is in an aspheric shape of a convex surface protruding toward the Z-axis direction minus side outside of the effective diameter range of Y-axis direction (i.e., an area of −8.0 mm to −6.0 mm, 6.0 mm to 8.0 mm (i.e., the second area 104b)). That is, the first surface of the hybrid lens 100 of example 1 has a concave surface and a convex surface formed in the Y-axis direction, and a point (called an inflection point) at which the concave surface and the convex surface are shifted. Additionally, the amount of sag Z is maximum (about 10 μm) at an inner position (in this embodiment, at the position of Y=±7.0 mm) than the outer edge of the second area 104b that is outside of the effective diameter range of Y-axis direction.

On the other hand, when viewed from the X-axis direction, the first surface of the hybrid lens of comparative example 1 is in an aspheric shape of a concave surface recessed toward the Z-axis direction plus side from the effective diameter range to an area (i.e., an area of ±8.0 mm (Y-axis direction)) outside of the effective diameter range. Additionally, the absolute value of the amount of sag Z of Y-axis direction is maximum (about 15 μm) at the end of Y-axis direction (i.e., at the position of Y=±8.0 mm), and the end of Y-axis direction is sharp in an angular shape.

As in comparative example 1, when the amount of sag Z is larger, so-called sink marks are more likely to occur. Additionally, when a sink mark occurs, it does not only affect the area outside of the effective diameter range, and there is a risk that its influence extends to the effective diameter range. Additionally, as in comparative example 1, when the end of Y-axis direction is sharp in an angular shape, this part is susceptible to cracking and splitting after molding. That is, the hybrid lens of comparative example 1 has a low yield when compared with the hybrid lens 100 of example 1.

As described above, the hybrid lens 100 of example 1 has higher order aspheric coefficients above second-order at the area (i.e., the second area 104b) outside of the effective diameter range of Y-axis direction (i.e., in −8.0 mm to −6.0 mm, 6.0 mm to 8.0 mm, and is in the aspheric shape of the convex surface protruding toward the Z-axis direction minus side. By this reason, the amount of sag Z is smaller than that of comparative example 1, the occurrence of sink marks is suppressed, and a high precision aspheric shape can be formed (i.e., a high yield is maintained). Additionally, in the hybrid lens 100 of example 1, an inflection point having a specific local curvature is generated according to the lens position at the second area 104b, and for example, the inflection point may be used in the position alignment when measuring in three dimensions as an alignment mark. Additionally, in the process of manufacturing the hybrid lens 100 of example 1, the mold M having the molding surface F that matches the surface shape of the resin layer 104 is used, and the molding surface F has the concave part that matches the aspheric shape of the convex surface outside of the effective diameter range of Y-axis direction, and thus the UV curable resin R is likely to stay within the range of the first area 104a and the second area 104b. That is, because the aspheric shape of the convex surface is formed outside of the effective diameter range of the hybrid lens 100, it is possible to increase the close contact between the UV curable resin R and the molding surface F, thereby increasing the molding and transfer performance.

While the embodiment of the present disclosure has been hereinabove described, the present disclosure is not limited to the configuration of the above-described embodiment, and various modifications may be made thereto within the scope and technical spirit of the present disclosure.

For example, although in the hybrid lens 100 of this embodiment, the aspheric shape of the convex surface protruding toward the Z-axis direction minus side is formed in the area (i.e., the second area 104b) outside of the effective diameter range of Y-axis direction, it is not necessarily limited to the aspheric shape if the amount of sag Z is small (i.e., an inflection point is provided). However, as shown in example 1, when it is shaped as a single aspheric surface over the first area 104a and the second area 104b, it is desirable because lens design is easy.

Additionally, although the hybrid lens 100 of this embodiment is the continuous lens that is incorporated into the fθ lens of the scanning optical system, and primarily corrects the bending of the scanning beam, the present disclosure may be applied to continuous lenses having different purposes and functions.

Additionally, although the hybrid lens 100 of this embodiment is described as the continuous lens of a rectangular plate shape, the present disclosure may be applied to lenses of different shapes, for example, a cylindrical lens.

Additionally, although the X-axis direction shape of the first surface of the hybrid lens 100 of this embodiment is described as being left-right asymmetric, it may be left-right symmetric.

Additionally, although this embodiment describes that the first surface of the hybrid lens 100 is in the aspheric shape of the concave surface recessed toward the Z-axis direction plus side in the effective diameter range (i.e., the area of ±40 mm (X-axis direction)×±6.0 mm (Y-axis direction)) when viewed from the X-axis direction, the entire area of the effective diameter range does not need to be a concave surface, and part of the effective diameter range may be a concave surface.

Additionally, although the glass 102 is in the shape of a flat plate in this embodiment, the present disclosure may be applied to the glass 102 having a base curve formed on the surface (i.e., the surface on the resin layer 104 side) thereof. In such case, to match the resin thickness, a relative shape to the base curve is handled as an amount of sag.

Additionally, it should be understood that the disclosed embodiments are illustrative in all aspects and are not limitative. The scope of the present disclosure is defined by the appended claims rather than the foregoing description, and is intended to cover all changes within the appended claims and their equivalent meaning and scope.

### DETAILED DESCRIPTION OF MAIN ELEMENTS

1 . . . Semiconductor laser
3 . . . Collimator lens
5 . . . Light deflector
7 . . . fθ lens system
9 . . . Scan target surface
100 . . . Hybrid lens
102 . . . Glass
104 . . . Resin layer
104a . . . First area
104b . . . Second area

1. A composite optical device having a resin layer on a surface of a glass of an elongated rectangular plate shape,
wherein the resin layer has a first area corresponding to an effective diameter range that is long along a lengthwise direction of the glass, and a second area disposed outside of a widthwise direction of the effective diameter range,
a surface of the resin layer has an aspheric shape, and
the aspheric shape is left-right asymmetrical in at least one cross section along the lengthwise direction, and includes a concave shape within the first area of at least one cross section along the widthwise direction, and an inflection point and a convex shape within the second area.

2. The composite optical device according to claim 1, wherein an amount of sag is maximum at an inner position than an outer edge of the second area.

3. (canceled)

4. The composite optical device according to claim 1, wherein the aspheric surface is formed as a single two-dimensional polynomial aspheric surface.

5. The composite optical device according to claim 4, wherein the aspheric surface of the first area includes a quadratic function component of the two-dimensional polynomial aspheric surface in the widthwise direction, and an odd-order function component of the two-dimensional polynomial aspheric surface in the lengthwise direction.

6. The composite optical device according to claim 4, wherein the aspheric surface of the second area includes a higher order component of the two-dimensional polynomial aspheric surface that is higher than second-order.

7. (canceled)

8. The composite optical device according to claim 1, wherein the amount of sag of the resin layer is 10 μm or less.

9. A scanning optical system, comprising:
the composite optical device defined in claim 1,
wherein the scanning optical system is configured to allow a light beam deflected in a main scanning direction to pass through the composite optical device, and scan over a predetermined surface.

10. The scanning optical system according to claim 9, wherein the composite optical device corrects a scan bending in the surface.

11. The composite optical device according to claim 5, wherein the aspheric surface of the second area includes a higher order component of the two-dimensional polynomial aspheric surface that is higher than second-order.

12. The composite optical device according to claim 2, wherein the amount of sag of the resin layer is 10 μm or less.

13. The composite optical device according to claim 4, wherein the amount of sag of the resin layer is 10 μm or less.

14. The composite optical device according to claim 5, wherein the amount of sag of the resin layer is 10 μm or less.

15. The composite optical device according to claim 6, wherein the amount of sag of the resin layer is 10 μm or less.

16. The composite optical device according to claim 11, wherein the amount of sag of the resin layer is 10 μm or less.
